(19) United States
(12) Patent Application Publication
(10) Pub. No.: US 2024/0054499 A1
(43) Pub. Date: Feb. 15, 2024

(54) LOST ITEM RETRIEVAL PLATFORM AND METHOD

(71) Applicant: Karin Louise Nagle, Westmont, IL (US)

(72) Inventor: Karin Louise Nagle, Westmont, IL (US)

(21) Appl. No.: 17/819,684

(22) Filed: Aug. 15, 2022

(51) Int. Cl. G06Q 30/00; G06K 19/06; H04L 51/04

(52) U.S. Cl. CPC G06Q 30/016; G06K 19/06037; H04L 51/04

(57) ABSTRACT

A method of facilitating return of an article from a finder to an owner includes providing a server computer which receives contact information of the owner; registers the article in association with a quick response (QR) code and with the owner's contact information; generates a tag or digital image that displays the QR code; directs the finder to a uniform resource locator hosted by the server in response to the finder scanning the QR code; retrieves the owner's contact information; and generates an anonymous chat session between the owner and the finder. The server includes a processor and a memory module having a database. A user flow based on item status logic provides a situation-based user experience.

### BACKGROUND OF THE INVENTION

The present invention relates to a system for facilitating return of lost items to their owners and, more particularly, to a lost item retrieval platform and method.

Finders of lost items want to do good by returning the lost items to their rightful owners in a quick, easy, and effective way. Traditional contact methods are outdated, lack privacy measures, and are inefficient. No solutions currently exist to incentivize finders to help search for, and to return, lost items by means of a reward seekers map. Existing methods either do not have any reward incentive or they only have owner specified rewards. No currently available platform tracks a lost item with status-based logic. Currently available solutions are ineffective in specific situations. Even though some solutions provide some of the above features, no solution provides all the solutions on one platform. Owners of personal items need an all-inclusive solution to provide their items a level of protection and to enable lost goods to be returned to owners.

As can be seen, there is a need for a means to incentivize and facilitate return of lost items to their owners while maintaining privacy of the parties involved.

### SUMMARY OF THE INVENTION

In one aspect of the present invention, a method of facilitating returning of an article from a finder of the article to an owner of the article comprises providing a server computer comprising a processor and a memory module having a database; receiving, by a server computer, contact information of the owner; registering the article in association with a quick response code and with the contact information of the owner; generating a tag or digital image that displays the quick response code; directing the finder to a uniform resource locator hosted by the server computer in response to the finder scanning the quick response code; retrieving, by the server computer from the database, the contact information of the owner; and generating, by the server computer, an anonymous chat session between the owner and the finder.

In another aspect of the present invention, a computer implemented system for facilitating return of an article from a finder of the article to an owner of the article comprises a network accessible backend server configured to: collect and store owner information; collect and store protected item information associated with the owner information; register the protected item with a quick response code; return to the owner an image of the quick response code; return an invitation to an anonymous chat upon receipt of the quick response code from the finder; and administer the anonymous chat.

The quick response code may be previously generated or may be generated through the app at the time of registration.

These and other features, aspects and advantages of the present invention will become better understood with reference to the following drawings, description, and claims.

### BRIEF DESCRIPTION OF THE DRAWINGS

FIG. 1 is a top-level flow chart of a method according to an embodiment of the present invention;

FIG. 2 is another flow chart thereof, illustrating QR code generation;

FIG. 3 is another flow chart thereof, illustrating changing an item status to “lost”;

FIG. 4 is a continuation of the flowchart of FIG. 3, illustrating changing an item status to “found”;

FIG. 5 is another flow chart thereof, illustrating method steps following scanning a QR code;

FIG. 6 is a continuation of FIG. 5;

FIG. 7 is another flow chart thereof, illustrating access of a reward seekers map;

FIG. 8 is a schematic view of a mobile device screen operating according to the method of FIG. 1;

FIG. 9 is another schematic view thereof;

FIG. 10 is another schematic view thereof;

FIG. 11 is another schematic view thereof;

FIG. 12 is another schematic view thereof;

FIG. 13 is another schematic view thereof;

FIG. 14 is another schematic view thereof; and

FIG. 15 is a system diagram according to an embodiment of the present invention.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, one embodiment of the present invention is a lost item retrieval platform or system for a finder to return a lost item to its owner and a method for a finder to return a lost item to its owner. The system may include a reward seekers map, digital quick response (QR) code generation, platform-generated rewards in addition to rewards provided by item owners, and an anonymous communication platform operative as communication means between the finder and the owner. The system may be both mobile app- and web-based. Each item may be categorized under a status dependent on a predetermined set of rules. The system provides an optimized user experience and an efficient solution to connect owners and finders.

The mobile application is sometimes referred to herein as the “LostIt Tag” app.

Preferably, the system provides web functionality so that finders are not required to have a mobile app to communicate with item owners. The user's mobile device electronically communicates with a network accessible server operating the app.

The platform provides a map of lost items (i.e., a reward seekers map). Items marked as lost by users on their mobile app appear on the map. This protects the users of the platform by providing a way for finders of lost items (other users or reward seekers) to search for and find lost items to be returned. Reward-seeking finders may access the lost items map to see nearby items that have been marked as lost, the name of the item to look for, an image of the item and a reward amount. The app user may zoom in and out, pan the map to view other nearby lost items, and recenter to go back to their live location. Lost items may be overlaid on the map as a pin that is placed on the last known location of the lost item. The user may select any lost item pin to partially expand the details on the specific item selected. In the case of multiple lost items in the same vicinity, the user may move from one item to another by quick tapping the information banner displaying partial information on the lost item. The user may fully expand the lost items information by opening the item from the information bar.

Item details may include the name of the item, an enlarged image of the item, a full list of rewards, any special instructions, and a button that directs the finder to the mobile app's scanner when the item is found. Partial item details may include the item name, a small item image, a reward amount, and last known locations.

The inventive system enables users to add an optional reward amount. The server may be configured to award platform-generated rewards to the finder upon return of the article to the owner. The platform may provide rewards to finders above and beyond what the item's owner has specified. For example, a finder may accumulate points. By enabling reward seekers to seek lost items in exchange for a reward through the platform, item owners have an even higher chance of having their items returned to them.

According to an embodiment of the inventive process, a user may associate a QR code with one or more personal items. QR codes may be acquired by users either by purchasing a QR code or by generating a QR code from the mobile app. The users may assign information to the unique code using the mobile app. QR codes may be activated by scanning the QR code (in the event of a purchased QR code) or by generating a QR code and applying an in-app credit to the item. The digital QR code may be immediately visible in the app and available for the user to print or download.

The QR code directs anyone scanning it to a uniform resource locator (URL) that points to a backend location or, in some embodiments, a data set. By pointing to a URL instead of a data set, the platform enables users to change information associated with their QR code any time. The result obtained when scanning a QR code depends on the item status, who is scanning the QR code (finder or owner, etc.), and other parameters.

By saving personal information in a database and simply directing finders to owners in an anonymous chat, private information may be kept private. The finder is not required to manually enter any identification code or unique ID to initiate the process, ensuring that items may be returned in a quick, easy, and effective way.

A user flow based on item status logic provides a situation-based user experience. The status types may include: “Active”, “Inactive”, “Lost”, and “Found”. The status may be set primarily as a function of owner and finder interactions.

A successful activation results in an “Active” item status. With an “Active” item status, users may mark items as lost on their mobile app. An “Active” status enables finders to return a lost item.

Without these actions, an item status remains “Inactive”. By selecting an inactive item from the home screen, a user may continue the activation process where they left off, but finders may not return lost items until an item activation has been successful.

When a user realizes an item is lost, they may mark their item as lost. Lost items may be displayed on the reward seeker map. Other nearby users of the app may be alerted when an item has been marked as lost and may see the lost item's details, including the rewards.

Once the item is found, the finder may scan the QR code on the lost item (with a “Lost” or “Active” status). When a quick response (QR) code on a lost item is scanned by a finder, the owner may receive a system-generated message indicating that the lost item has been scanned, along with the name of the item and the scanning location. The finder may be immediately directed to a URL with information associated with the lost item, including the name of the lost item, any special instructions, and a reward amount. Item status logic offers a user flow that provides a situation-based user experience over a range of different scenarios.

The finder and the item's owner may communicate anonymously through the app via an anonymous chat session and arrange return details anonymously, without sharing any personal information.

The item owner may accept or deny that the item has been found. Upon owner acceptance, the item Status becomes “found”. With the “found” status, users have easy access to track the item location and communicate with the finder, view, increase reward amounts, and quick scan a code upon return. A scan of a returned item's QR code by the owner automatically adjusts the item status to “Active” again.

In some embodiments, delivery services may be integrated to return the items to their owners, keeping the delivery address and other personal information secure and anonymous from finders.

The system may be produced by developing user flow and interface, front and backend software, setup and integration with an online store, and setup and integration with secure and anonymous communication platforms into a mobile application with an associated web module enabling a user's mobile device, such as smart mobile phones, to scan quick response (QR) codes to initiate predetermined method steps.

The system may be used in several ways, including the following examples.

When preparing for travel, an owner may attach a LostIt Tag QR code sticker to a personal item. If the personal item is lost, a finder who scans the QR code may immediately be directed to a chat in which both the finder's and the owner's contact information is disguised. The owner may be alerted that the personal item was found along with a location of where it was scanned.

A young woman may apply a QR code sticker on her item instead of writing her personal contact number where any stranger can see prior to having a drink at the bar. If a stranger tries to scan her item just to get her number, the user may block unsolicited chats.

At a festival entrance gate, a user may receive a small brochure with instructions on how to use the inventive system to keep a cell phone safe, including downloading the LostItTag app, saving the item with, for example, the user's best friend's phone number, and generating, downloading, and saving a QR code as the phone's screen saver. If the user later realizes the phone is lost, he or she may tell the best friend. The best friend may have received a short messaging service (SMS) notification indicating somebody found the phone.

Edgar is at the bus stop and just realized he does not have his wallet with him. Edgar needs cash quickly to get home. Edgar accesses the LostItTag app on his phone. He selects the map option and then sees a list of items that have been marked as lost. Edgar sees there is a lost item in the area or predetermined region with a reward amount. He starts looking in the area for it, and finally, he finds it! He scans the quick response (QR) code and the item owner is automatically alerted. Both parties are immediately put in contact with each other through an anonymous chat, through which they arrange the item return, such as via an in-person meeting or a drop off delivery. The owner pays the predetermined monetary reward, whether physically (in-person) or digitally through the app. Edgar decides to become a full-time reward seeker for LostIt Tag and gets notifications when someone in the area loses an item. Edgar and other reward seekers just like him, get lucrative rewards, by doing good and helping other people reunite with their lost items.

The inventive system and method may also be used to track assets in an office.

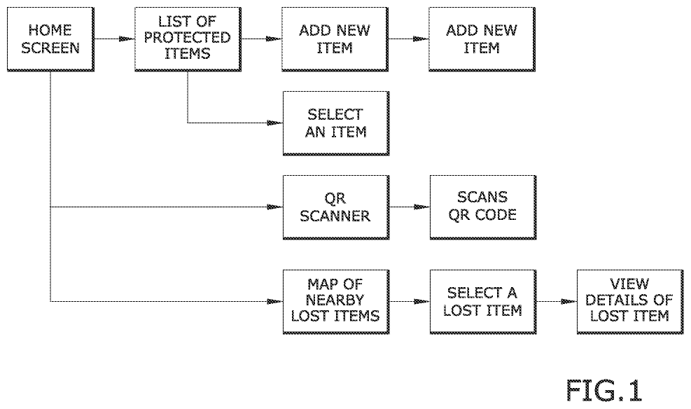

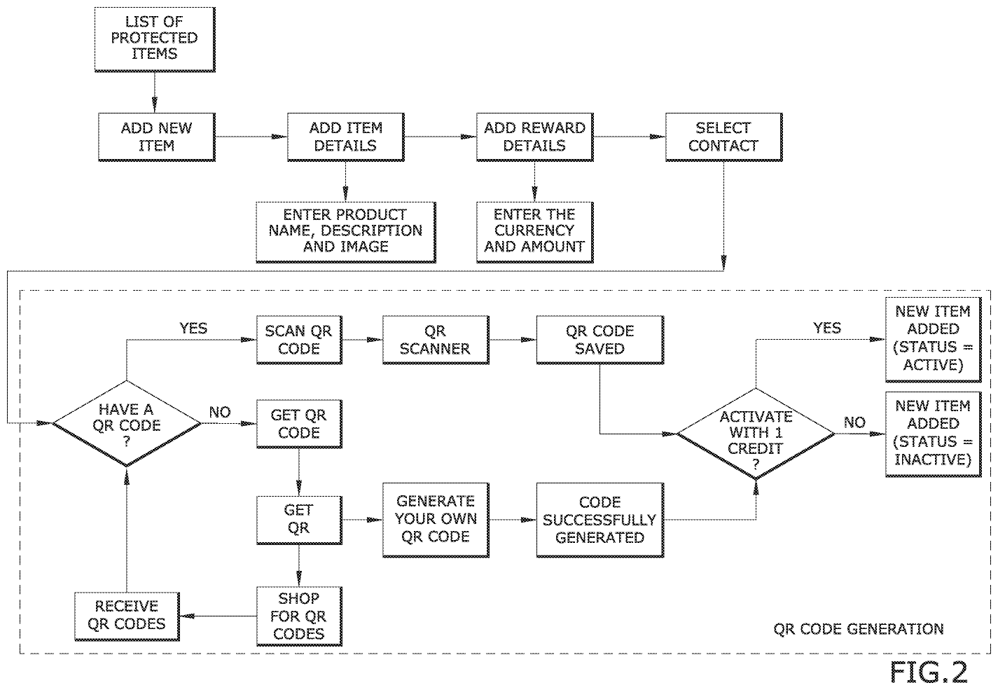

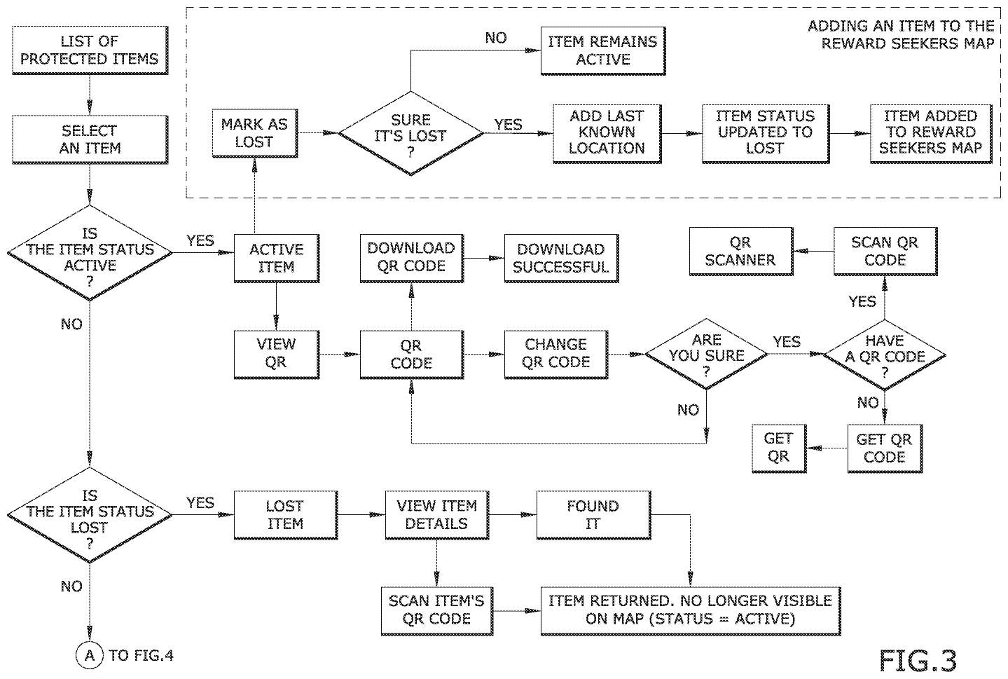

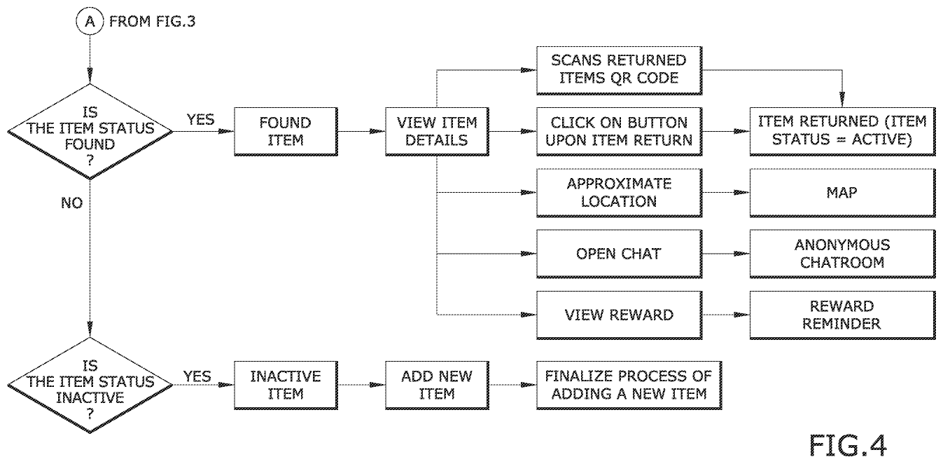

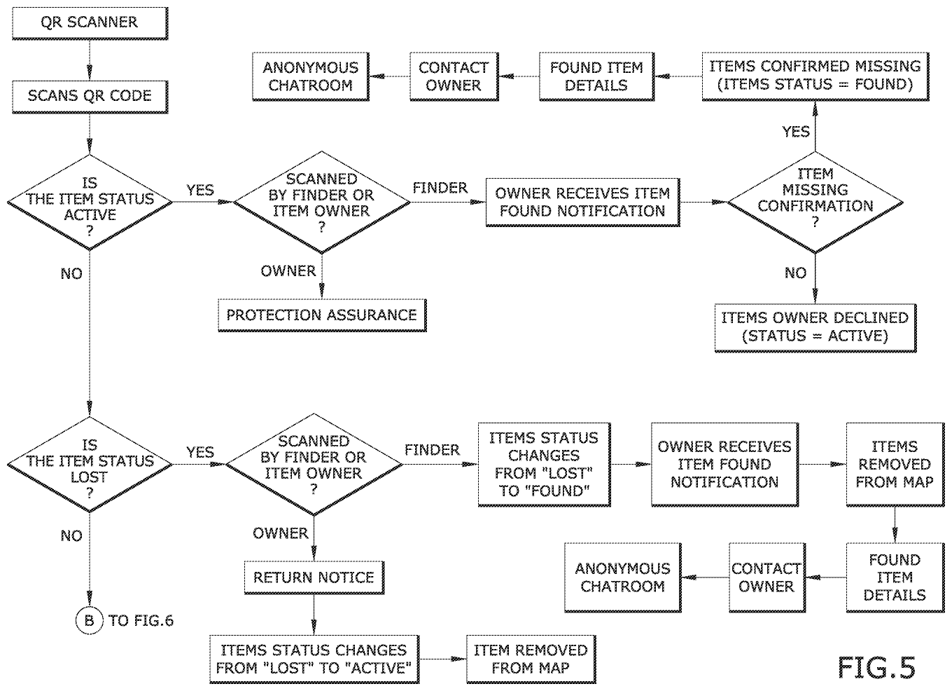

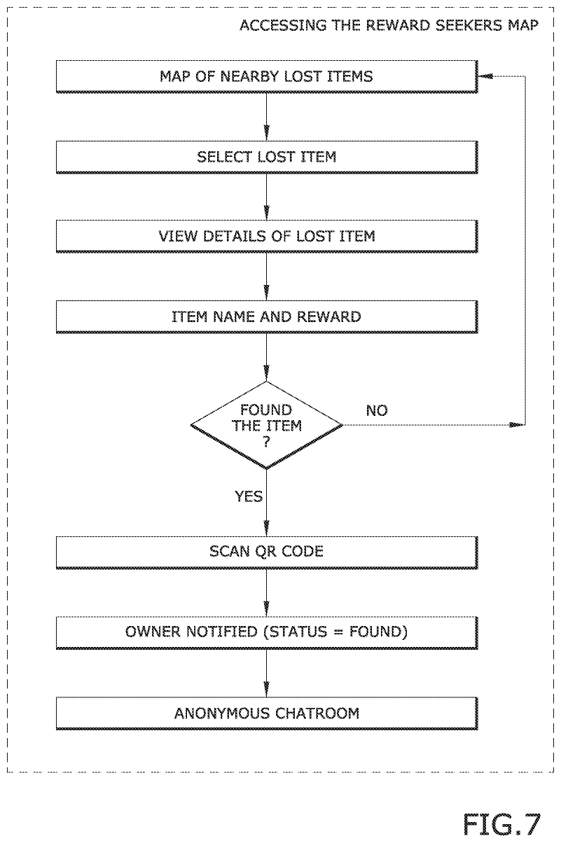

Referring to FIGS. 1 through 15, FIG. 1 is a flowchart illustrating steps according to an embodiment of the present invention. A user accessing a home screen Main Menu may select from a list of the user's protected items, a QR scanner, or a map of nearby lost items. If the list of protected items is selected, the user may add new items (see FIG. 2) or select an existing item (see FIG. 3). If the user selects the QR scanner, the user may scan a QR code (see FIG. 5). If the user selects the map of nearby lost items, the user may select and view the details of a lost item (see FIG. 7).

New items may be entered with item details selected from but not limited to: Product Image and Special instructions, reward details including Currency and Reward amount, and Select contact to associate with a QR code, as shown in FIG. 2. FIG. 2 illustrates QR code generation and/or activation. If the user has a QR code, the user may Scan the QR code and Activate protection using one credit. Item status changes from “Inactive” to “Active”. Alternatively, the user may generate a QR code or purchase a QR code and activate it. In some cases, the new QR code may automatically be generated and assigned in the background. The user may also change the QR code associated with a specific item, as shown in FIG. 3. The QR code may be downloaded to a mobile phone.

FIGS. 3-4 illustrate the status-based logic guiding the sequence of method steps, depending upon whether an item's status is active, lost, found, or inactive. An owner may mark the item as lost, confirm that the item has been lost, and enter the last known location for the item. The item status changes to “Lost” and the item may be visible on the “map”. Once an item is “Lost”, the finder may select the item from the map and scan the QR code attached to the lost item with their phone, changing the status to “Found”. The system documents an approximate location of where the item was scanned and issues a notification for an anonymous chat. Once the finder returns the item to the owner, the owner may select a “Found it” button on the app or scan the QR code to indicate that the item is no longer lost. The item status reverts from “Found” to “Active” and the item is no longer visible to reward seekers on the map. Any reward may then be transferred to the finder.

When an item status is “inactive”, it either means the user did not complete the info on the “Add a new item” screen, or there is no QR code associated with the item, which may be because a protection credit has not yet been applied. Until the user completes the activation process, the item status remains “inactive”.

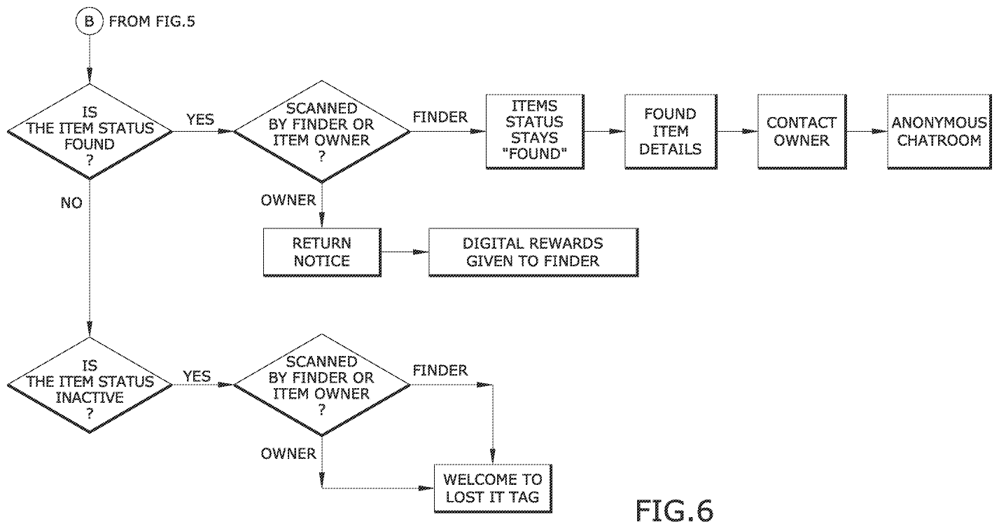

FIGS. 5-6 illustrate the different steps that may occur depending upon the item status and the role of the user scanning a QR code.

An item may be “Found” by a finder even if the item has not been reported as “Lost” by the owner. However, the item only appears on the LostIt rewards seekers map if it has been reported as “Lost”. If an “Active” item is scanned by a finder, the status may change directly from “Active” to “Found”. Once the owner confirms item receipt, the status returns to “Active”.

If the item status is “lost” and the QR code is scanned by the owner, the item status reverts from “Lost” to “Active” and is no longer visible to reward seekers on the map. The item location and any chat are moved to “Item History”.

FIG. 7 illustrates use of the Map on a Finders Module. The finder may view a map screen of nearby items that have been lost, with reward amounts. The finder may select an item from the map to partially expand information on a specific item including item name, last known locations, and reward amount. Upon selecting the partially expanded item, the finder may view additional details of items including, for example, the Item name, Rewards, Special Instructions, and a Scan item button which Opens a QR scanner. In the event a finder locates a lost item shown on the map, the finder may scan the QR code on the item, notifying the owner that the item has been found. The notification may be a push notification, such as a short messaging service (SMS) message or email, with a message such as “Lost Item has been found. Please go to your LostIt Tag app to see location and other details, as well as to access the anonymous communication with finder”. The finder and the owner may engage in an anonymous chat, activated and accessible after a finder finds and scans a user's lost item, to discuss specifics for delivery. No personal information about either party is disclosed. Phone number and name are anonymous. As long as the chat has been activated and remains open, the user may continue communicating with the finder. Previous (historical) or open chats associated with an item may also be viewed.

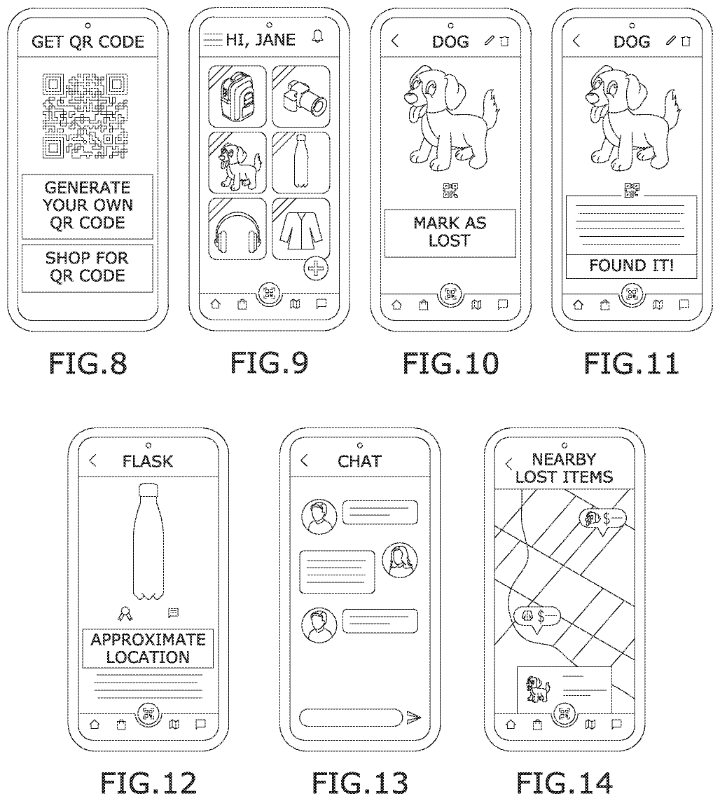

FIGS. 8 through 14 illustrate various screen images that may be viewed by a user, whether an owner or a finder, in the process of using the inventive system, including obtaining a QR code in FIG. 8, selecting an item from a list in FIG. 9, marking an item as lost in FIG. 10, notifying the owner that the item is found in FIG. 11, providing an approximate location of a found item in FIG. 12, conducting an anonymous chat in FIG. 13, and viewing a map of nearby lost objects in FIG. 14.

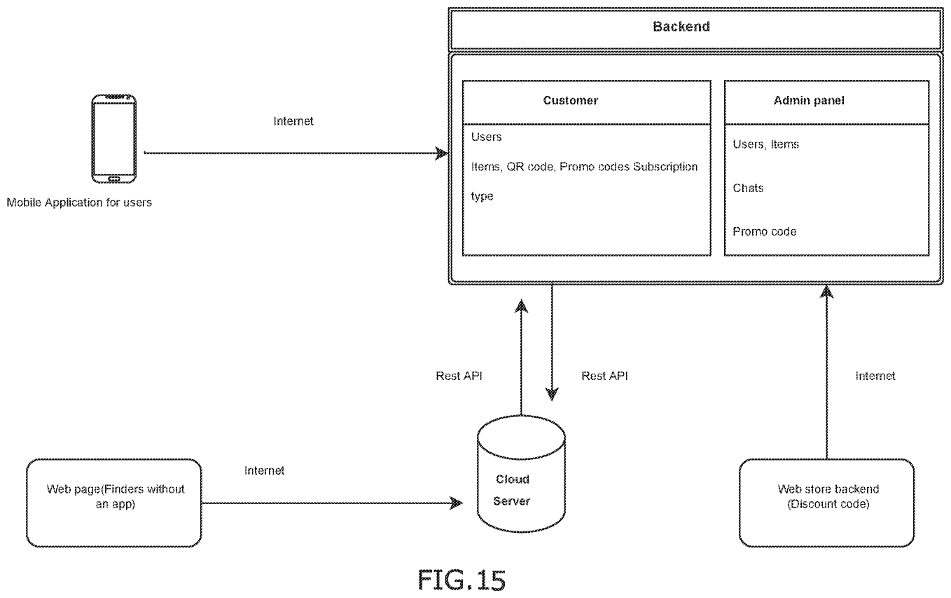

As shown in FIG. 15, a system according to an embodiment of the present invention comprises a backend server that is partitioned into a first component configured to interact with a user's mobile device via an app over the internet and a second, administrative component that interacts with a web store backend via the internet. The backend server interacts with a cloud server via a representational state transfer application programming interface (REST API). Users without an app may also interact with the system through the cloud server via the internet.

It should be understood, of course, that the foregoing relates to exemplary embodiments of the invention and that modifications may be made without departing from the spirit and scope of the invention as set forth in the following claims.

What is claimed is:

1. A method of facilitating return of an article from a finder of the article to an owner of the article, comprising:
a. providing a server computer comprising a processor and a memory module having a database;
b. receiving, by the server computer, contact information of the owner;
c. registering the article in association with a quick response code and with the contact information of the owner;
d. generating a tag or digital image that displays the quick response code;
e. directing the finder to a uniform resource locator hosted by the server computer in response to the finder scanning the quick response code;
f. retrieving, by the server computer from the database, the contact information of the owner; and
g. generating, by the server computer, an anonymous chat session between the owner and the finder.

2. The method of claim 1, further comprising generating a lost items map displaying a last known location for items having a “lost” status within a predetermined region.

3. The method of claim 1, further comprising generating the quick response code prior to registering the article.

4. The method of claim 1, further comprising incentivizing the finder to search for the article by awarding platform-generated rewards when the article has been returned to the owner.

5. The method of claim 1, further comprising setting a status of the article selected from the group consisting of “inactive”, “active”, “lost”, and “found” as a function of owner and finder interactions with the server computer.

6. A computer implemented system for facilitating return of an article from a finder of the article to an owner of the article, the computer implemented system comprising:
a. a network accessible backend server configured to:
i. collect and store owner information;
ii. collect and store protected item information associated with the owner information;
iii. register the protected item with a quick response code;
iv. return to the owner an image of the quick response code;
v. return an invitation to an anonymous chat upon receipt of the quick response code from the finder; and
vi. administer the anonymous chat.

7. The computer implemented system of claim 6, further comprising a mobile device electronically communicating with the network accessible server, operative to display a lost items map generated by the network accessible server and to scan the quick response code.

8. The computer implemented system of claim 6, wherein the network accessible server is configured to award platform-generated rewards to the finder upon return of the article to the owner.

9. The computer implemented system of claim 6, further comprising an anonymous communication platform operative as communication means between the finder and the owner for the anonymous chat.

10. The computer implemented system of claim 6, wherein the network accessible server is configured to set a status of the article selected from the group consisting of “inactive”, “active”, “lost”, and “found” as a function of owner and finder interactions with the network accessible server.
